(19) United States
(12) Patent Application Publication
(10) Pub. No.: US 2025/0179987 A1
(43) Pub. Date: Jun. 5, 2025

(54) WIND TURBINE ROTOR BLADE AND METHOD OF JOINING TWO ROTOR BLADE SEGMENTS

(71) Applicants: Nordex Energy SE & Co. KG, Hamburg (DE); Nordex Blade Technology Centre ApS, Stenstrup (DK)

(72) Inventors: Jochen Birkemeyer, Norderstedt (DE); Markus Werner, Felde (DE); Gerald Festner, Klein Krams (DE); Torsten Wackrow, Rostock (DE); Flemming Sorensen, Stenstrup (DK)

(21) Appl. No.: 18/845,825

(22) PCT Filed: Mar. 10, 2022
(86) PCT No.: PCT/EP2022/056149

§ 371 Date: Sep. 10, 2024

(51) Int. Cl. F03D 1/06

(52) U.S. Cl. CPC F03D 1/0677; F05B 2230/604; F05B 2240/302; F05B 2260/301

(57) ABSTRACT

A wind turbine rotor blade is formed by at least two rotor blade segments, the segments being screwed together at respective connection ends of the segments via a plurality of connecting bolts, the connecting bolts being screwed into the first and second connection ends. A plurality of sleeve-shaped pretensioning units are arranged between the rotor blade segments, each of which is mounted on a corresponding connecting bolt. Each pretensioning unit includes a first and a second piece, wherein the first and the second piece engage each other in a form fit manner. The first and the second piece can be moved relative to each other along the corresponding connecting bolt by providing a force in an axial direction. The first and the second piece are axially pushed apart from each other along the corresponding connecting bolt against the respective connection ends, such that the corresponding connecting bolt is preloaded.

### CROSS-REFERENCE TO RELATED APPLICATIONS

This application is a continuation application of international patent application no. PCT/EP2022/056149, filed Mar. 10, 2022, designating the United States and the entire content is incorporated herein by reference.

### TECHNICAL FIELD

The disclosure concerns a wind turbine rotor blade with at least two rotor blade segments and a method for joining two rotor blade segments.

### BACKGROUND

Wind turbines with wind turbine rotor blades are widely known from the state of the art and are used to convert wind energy into electrical energy. Wind turbines include a multitude of components which are connected to each other, for example via a flange connection. For example, in the area of a rotor blade root, the rotor blades include a rotor blade connection with a number of connecting means integrated into the laminate, via which the rotor blades are connected to a bearing ring of a so-called pitch bearing or to a component connected to the bearing ring, such as a so-called extender for a wind turbine rotor blade, via fastening screws or fastening bolts. The connecting means can, for example, be configured as transverse bolts or bushings and be part of a flange insert for the rotor blade connection. Such a configuration is known from international application WO 2015/124568 A1.

The above-described connections are also used for connecting rotor blade segments which, arranged and joined together lengthwise, form an entire rotor blade. Such a rotor blade is called a split or segmented rotor blade. For example, connecting means are then located in the laminate of a respective connection end or dividing flange of the rotor blade segments. The rotor blade segments can be connected to each other via bolts either directly or via suitable intermediate pieces.

Segmented rotor blades are preferred especially for transport reasons and are becoming increasingly important, especially due to the increasing overall length of rotor blades.

EP 3 441 561 A1 relates to a device for joining a modular blade. With respect to the figures, the joint of two blade modules 1 and 2 are formed by a plurality of bolts 8 that are secured between inserts 3 and 4 housed in the composite material of two modules 1 and 2 to be jointed. The device allows the bolts 8 to be preloaded. For the purpose, each device is formed by lateral caps 9, an upper wedge 10 and a lower wedge 11, and transverse screws 12, all of this surrounding the corresponding bolt 8 disposed inside of a hole between two blade modules 1 and 2. When a force F1 is applied to the wedges 10 and 11, the caps 9 respond with a force that separates the modules 1 and 2 and pre-stress the bolt 8. Thus, the force F1 is directed orthogonal to a length of the respective bolt 8 and is transferred to an axial force via the wedges 10 and 11. For example, according to this solution friction losses occur and high forces for preloading the bolts are necessary. Further, precise adjustment of the preload forces is difficult. Furthermore, many components are involved, which makes the adjustment process time-consuming.

It is also known that a pressure piece is arranged between the rotor blade segments for each bolt connection. The disadvantage of such pressure piece is the rather large distance between adjacent pressure pieces. These pressure pieces are subjected to a preload force which depends a tightening factor between minimum and maximum preload. This might require larger bolts which can be loaded less. Apart from this, the bolt connections with pressure pieces have to be tightened time-intensively on site.

### SUMMARY

It is an object of the present disclosure to specify a concept for segmented rotor blades which ensures a particularly advantageous connection of rotor blade segments, thereby avoiding or at least reducing the above-mentioned problems.

The object is, for example, achieved by a wind turbine rotor blade including: a plurality of connecting assemblies and each of the connecting assemblies including: first and second rotor blade segments having respective connection ends; a connecting bolt threadably engaging into the first and second connection ends; a sleeve-shaped pretensioning unit arranged between the first and second rotor blade segments and being mounted on the connecting bolt; the pretensioning unit including first and second pieces mutually engaged in a form fit manner; the first and second pieces being movable relative to each other along the connecting bolt by applying a force in an axial direction; and, the first and second pieces being configured to be axially moved apart from each other along the connecting bolt against the respective connection ends so as to cause the connecting bolt to be preloaded.

According to the disclosure a wind turbine rotor blade is disclosed, which is formed by at least two rotor blade segments, the segments being screwed together at respective connection ends of the segments via a plurality of connecting bolts. The connecting bolts are screwed into the first and second connection ends. A plurality of sleeve-shaped pretensioning units is arranged between the rotor blade segments, each of which is mounted on a corresponding connecting bolt. Each pretensioning unit includes a first piece and a second piece, wherein the first piece and the second piece engage each other in a form fit manner. The first piece and the second piece can be moved relative to each other along the corresponding connecting bolt by providing a force in an axial direction. The first piece and the second piece are axially pushed apart from each other along the corresponding connecting bolt against the respective connection ends, such that the corresponding connecting bolt is preloaded.

For connecting the two rotor blade segments of a wind turbine rotor blade, these typically include a large number of corresponding connecting elements, such as bushings, at the connection ends to be connected. The connecting elements are used to create a large number of bolt connections between the two segments. The assembly is, for example, configured in such a way that the connecting bolts are first screwed into a connection end of one rotor blade segment, for example, into the bushings. Then the pretensioning units are pushed onto the connecting bolts before the free ends of the connecting bolts are threaded into the corresponding connecting element of the other rotor blade segment and at least partially screwed in. Then, the two rotor blade segments are bolted together, whereby the connection is screw-bolted with a predetermined force, for example, by using respective assembly tools. Thus, the pretensioning units just fit between the rotor blade segments or are at least slightly clamped between the rotor blade segments. Finally, the pretensioning units are then actuated, that is, the two pieces are pushed apart and, if the predetermined pretension is reached, locked/held in this position. Thus, each bolt is pretensioned (or preloaded). Preloading/pretensioning means that the respective bolt is pulled or stretched in length by the pretensioning unit.

The inventive wind turbine rotor blade and in particular the described pretensioning units provide several technical effects and advantages. For example the disclosure enables that pretensioning forces can be high and precisely adjusted. Further, a very high strength for a bolt connection is achievable. Further, a precise preload force can be achieved, wherein a tightening factor is about 1,2. Further, the disclosure enables or contributes to a simple, safe and fast assembly.

A pretensioning unit is configured as a sleeve unit, that is, the pretensioning unit includes the two pieces and includes a continuous bore/opening along a main direction of extension, that is, a longitudinal axis.

The first and second pieces are axially movable relative to each other. The first and second pieces engage each other, for example, by being at least partially in contact, such that axial forces can be transferred from one piece to the other. The first and second pieces can be moved apart (pushed apart) in order to apply pressure on the connection ends and thus to preload the bolt. The pressure is applied to the connection flange, preferably to inserts embedded into the rotor blade segments. By moving the pieces apart from each other a distance between the connection ends of the rotor blade segments is increased. In its final position, that is, after being moved apart from each other to preload the respective bolt, the first and second pieces are held in position, for example, locked. In other words, the increased distance (under pressure) is maintained. Thus, the respective connecting bolt is preloaded.

A connecting bolt, for example, is a screw bolt. The connecting bolt is, for example, configured as an expansion shaft bolt (with corresponding external threads).

The connecting elements mentioned, such as the bushings, are elements laminated into the connecting ends of the rotor blade segments.

According to an embodiment, the first piece and the second piece of each pretensioning unit are rotatable to each other and coupled to each other via a thread, and wherein the first and second piece are be screwed apart from each other along the corresponding connecting bolt for preloading the corresponding connecting bolt. Here, the two pieces are moved/pushed apart from each other by using the threaded connection. This provides a very simple and reliable solution.

According to an embodiment, in the screwed-apart state of the first and second pieces, the position of the first and second pieces relative to each other can be secured by additional securing means, for example, a retaining/locking ring, a lock nut, a locking plate or the like, in order that the first and second piece cannot be screwed back.

According to an embodiment, the first piece or second piece is connected to the corresponding connecting bolt in a form fit manner, such that a screwing force can be applied to the corresponding connecting bolt. By applying a screwing force, for example, by rotating the first or second piece, the respective bolt can be screwed into the first and second connection ends. This is used for example for tightening the bolt connection prior to preloading the bolt.

The form fit connection (also named positive-locking connection) means that the first/second piece engages the respective bolt such that a torque about the longitudinal axis of the pretensioning unit can be transmitted to the connecting bolt for rotating, that is, screwing, the bolt. In other words, the form-fit connections are torque-proof. For example, the first/second piece includes an inner hexagonal shaped section engaging a mating hexagonal outer shape section of the respective bolt.

According to an embodiment, a screwing piece is located between the pretensioning unit and one of the rotor blade segments, the screwing piece being connected to the corresponding connecting bolt in a form fit manner, such that a screwing force can be applied to the corresponding connecting bolt. The screwing piece, for example, is a sleeve-like element, for example, a nut piece. The screwing piece can be rotated relative to the first and second piece. Instead of the first or second piece of the pretensioning unit, a separate screwing piece is used for screwing the bolt into the rotor blade segments. For example, there is no form-fit connection between the first and second piece and connecting bolt for screwing the connecting bolt. We refer to the above statements regarding the form fit connection, which similarly apply. The solution provides, for example, that during screwing of the screwing piece, the rotation essentially causes friction only at one connection end a respective rotor blade segment, wherein no friction is caused at both connection ends.

According to an embodiment, each pretensioning unit is formed as a hydraulic nut unit. With a hydraulic nut, the first and second piece are pushed apart from each other by applying hydraulic pressure in order to preload the respective bolt. A hydraulic nut particularly brings about the above-mentioned advantages and functions. In addition, no elements are rotated to each other during pressure apply for moving apart the first and second piece. For example, no friction is caused. After having applied hydraulic pressure, the axial position of the first and second piece is secured. Afterwards, the hydraulic pressure can be released again.

According to an embodiment, each second piece of a pretensioning unit formed as a hydraulic nut includes an external thread onto which a lock nut is screwed. The first piece and second piece of each pretensioning unit are pushed apart from each other, wherein the respective lock nut is screwed against the first piece, in order to hold the first piece and second piece in position relative to each other. Thus, the first and second piece are secured in their axial position, thus guaranteeing the preload.

According to an embodiment, the first piece and the second piece of each pretensioning unit form a hydraulic chamber fluidly connected to a hydraulic port of the first piece to apply hydraulic pressure on the first piece and the second piece to push them apart from each other. The chamber is sealed, for example by O-rings.

According to an embodiment, one of the first or the second piece of a pretensioning unit formed as a hydraulic nut is connected to the corresponding connecting bolt in a form fit manner, such that a screwing force can be applied to the corresponding connecting bolt. We refer to the above statements which similarly apply.

According to an embodiment, a screwing piece is located between the pretensioning unit and one of the rotor blade segments, the screwing piece is connected to the corresponding connecting bolt in a form fit manner, such that a screwing force can be applied to the corresponding connecting bolt. This applies for a pretensioning unit formed as a hydraulic nut. We refer to the above statements which similarly apply.

According to an embodiment, each hydraulic port of the hydraulic nut units is arranged at an outer side with respect to a longitudinal axis of the wind turbine rotor blade. In other words, the hydraulic ports are facing away from the longitudinal axis of the blade. This provides easy access during mounting of the hydraulic components.

According to an embodiment, the first or second piece of each pretensioning unit has a tool engaging section for an assembly tool, in particular a hexagonal shaped outer side or one or more boreholes. For screwing the bolts via the first or second piece of the pretensioning unit a respective assembly tool is used, for example, a hydraulic torque tool like an open swing tool or mounting pins or bolts. The assembly tool can also be named mounting tool or screw tool. The assembly tool engages a tool engaging section of the first or second piece, such that a rotation of the assembly tool rotates the first/second piece and thus the respective connecting bolt, due to the form-fit connection of the first or second piece with the respective connecting bolt. The tool engaging section is, for example, a hexagonal shaped section, wherein the assembly tool is configured accordingly to engage the first or second piece in the respective tool engaging section.

According to an embodiment, the first and/or second piece of each pretensioning unit or the screwing piece includes one or more centering means for centering the first and/or second piece along the corresponding connecting bolt with respect to the respective other piece and/or the adjacent connection end. For example, the centering means is a centering protrusion, a ring-like protrusion or the like. Thus, a perfect alignment between the pretensioning unit or the screwing piece with respect to the connection ends of the rotor blade segments can be achieved.

According to a second aspect, a method of joining two rotor blade segments of a wind turbine rotor blade according to an embodiment as described above is disclosed. The method includes the steps:
partially screwing connecting bolts into a first connection end of the first rotor blade segment in such a way that the connecting bolts project from the first connection end,
mounting sleeve-shaped pretensioning units to the connecting bolts to be arranged between the rotor blade segments, wherein each pretensioning unit includes a first piece and a second piece, wherein the first piece and the second piece can be moved relative to each other along the corresponding connecting bolt, and wherein the first piece and the second piece engage each other in a form fit manner,
bringing the second connection end of the second rotor blade segment close to the first connection end of the first rotor blade segment,
partially screwing the connecting bolts into the second connection end,
providing an axially directed force between the first pieces and second pieces of each pretensioning unit,
axially pushing the first pieces and the second pieces of each pretensioning unit apart from each other along the corresponding connecting bolts against the respective connection ends, such that the corresponding connecting bolts are preloaded.

The method essentially enables the above-mentioned advantages and functions. The above-described features and embodiments according to the first aspect similarly apply to the method.

According to an embodiment, the first piece and the second piece of each pretensioning unit are coupled to each other via a thread, and wherein—in the step of axially pushing—the first piece and the second piece of each pretensioning unit are screwed apart from each other for preloading the corresponding bolt. We refer to the above statements according to the first aspect.

According to an embodiment, each pretensioning unit is formed as a hydraulic nut unit, and wherein—in the step of axially pushing—the first piece and the second piece of each pretensioning unit are hydraulically pushed apart from each other for preloading the corresponding bolt. We refer to the above statements according to the first aspect.

According to an embodiment, each second piece includes an external thread onto which a lock nut is screwed, and wherein the first piece and second piece of each pretensioning unit are pressed apart from each other, wherein the lock nut is screwed against the first piece, in order to hold the first piece and second piece in position relative to each other. We refer to the above statements according to the first aspect.

### BRIEF DESCRIPTION OF DRAWINGS

The invention will now be described with reference to the drawings wherein:

FIG. 1 shows a schematic view of a wind turbine;

FIG. 2 shows a schematic view of a split rotor blade with two rotor blade segments;

FIG. 3 shows a schematic sectional view of a bolt connection of two rotor blade segments;

FIGS. 4 and 5 show a pretensioning unit according to an embodiment of the disclosure;

FIG. 6 shows a schematic sectional view of a pretensioning unit according to a further embodiment of the disclosure; and,

FIG. 7 shows a schematic sectional view of a pretensioning unit according to a further embodiment of the disclosure.

### DETAILED DESCRIPTION

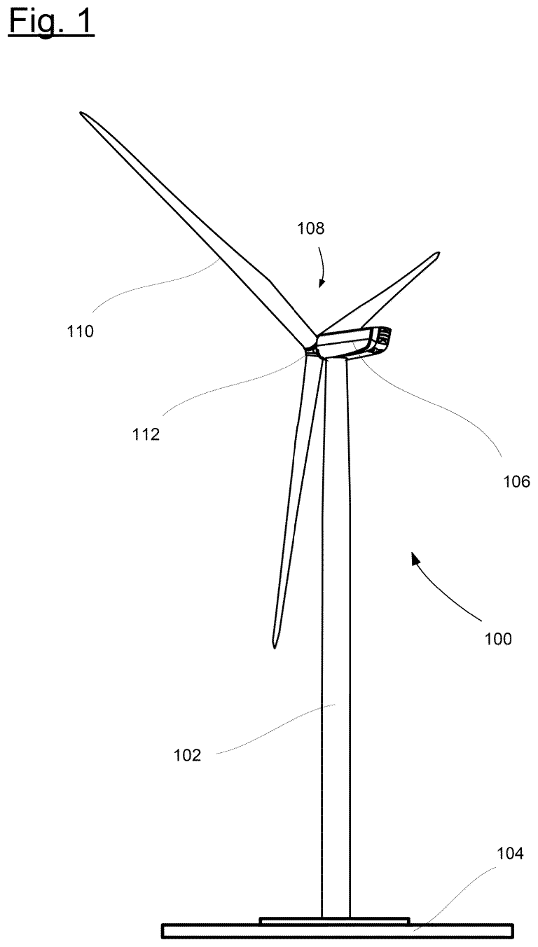

FIG. 1 shows a schematic view of a wind turbine 100, which includes a tower 102. The tower 102 is fixed to the ground via a foundation 104. At one end of the tower 102 opposite to the ground a nacelle 106 is rotatably mounted. The nacelle 106, for example, includes a generator which is coupled to a rotor 108 via a rotor shaft (not shown). The rotor 108 includes one or more (wind turbine) rotor blades 110, which are arranged on a rotor hub 112.

During operation, the rotor 108 is set in rotation by an air flow, for example wind. This rotational movement is transmitted to the generator via the rotor shaft and, if necessary, a gearbox. The generator converts the kinetic energy of the rotor 108 into electrical energy.

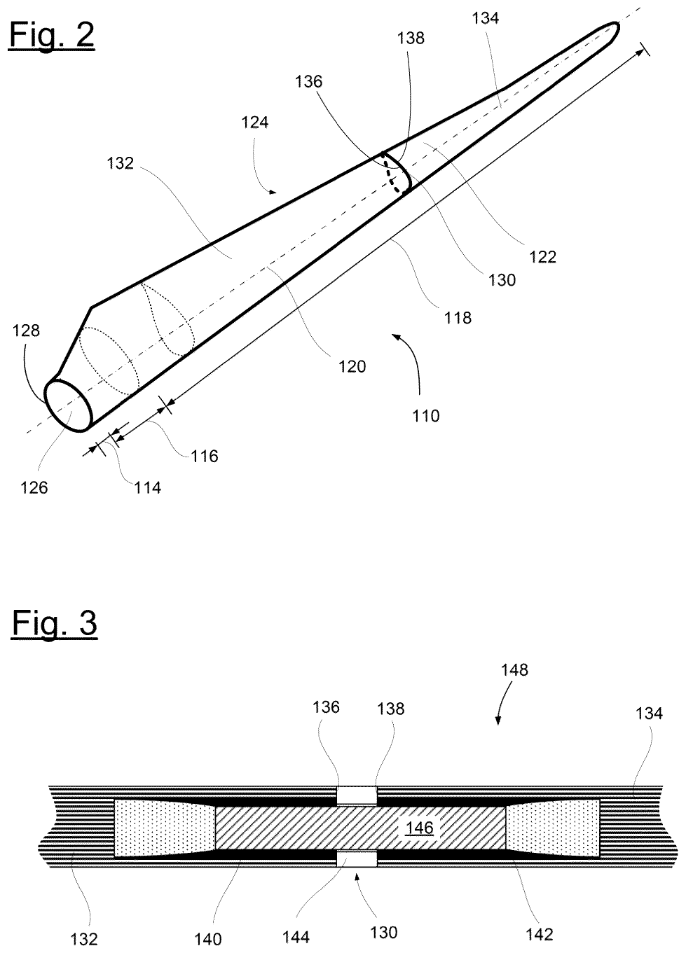

FIG. 2 shows a wind turbine rotor blade 110. The rotor blade 110 has the shape of a conventional rotor blade and has a rotor blade root area 114 facing the rotor hub 112. The rotor blade root area 114 typically has an essentially circular cross-section. The rotor blade root area 114 is followed by a transition area 116 and a profile area 118 of rotor blade 110. The rotor blade 110 has a pressure side 122 and an opposite suction side 124 with respect to a longitudinal extension direction 120 (also main extension direction). The rotor blade 110 is essentially hollow inside.

In the rotor blade root area 114 a rotor blade connection end 126 with a flange connection 128 is provided, via which the rotor blade 110 is mechanically connected to a pitch bearing or an extender.

The rotor blade 110 includes a division area 130 where a blade root-side rotor blade segment 132 and a blade tip-side rotor blade segment 134 are connected to each other. For this purpose, both segments 132, 134 each include a segment connection area 136, 138 (also connection ends). The rotor blade 110 is thus a split rotor blade as described above. Embedded into each connection end 136, 138 are a multitude of sleeves or bushings 140, 142 (see FIG. 3), which are arranged according to the profile (in circumferential direction) and include internal threads for the reception of screw bolts, also called bearing bolts or connecting bolts. For example, the first bushings 140 include left-hand threads (first internal threads) and the second bushings 142 right-hand threads (second internal threads) or vice versa. A connection end 136, 138 is realized for example as a flange insert, which is inserted as a prefabricated insert into a production mold for the manufacture of the rotor blade 110. However, it is also conceivable that no flange insert is provided and the bushings are embedded and laminated directly into the rotor blade half shells. The bushings are steel sleeves, for example.

FIG. 3 shows a schematic sectional view in a partial area of two connected rotor blade segments 132, 134 at the division area 130, where a single bolt connection 148 is shown. The first connecting end 136 of the first rotor blade segment 132 includes a multitude of first bushings 140. The second connection end 138 of the second rotor blade segment 134 includes a number of second bushings 142. A connecting bolt 146 is screwed into each pair of aligned first and second bushings 140, 142. This bolt 146 connects the two connection ends 136, 138 and thus the two rotor blade segments 132, 134 mechanically.

In addition, a pretensioning unit 144 is clamped between the two connection ends 136, 138 per bolt connection 148. By the help of the pretensioning units 144, the bolts 146 can be preloaded.

In the following, pretensioning units 144 according to embodiments of the disclosure are described in more detail wherein exemplarily it is referred to a single bolt connection 148.

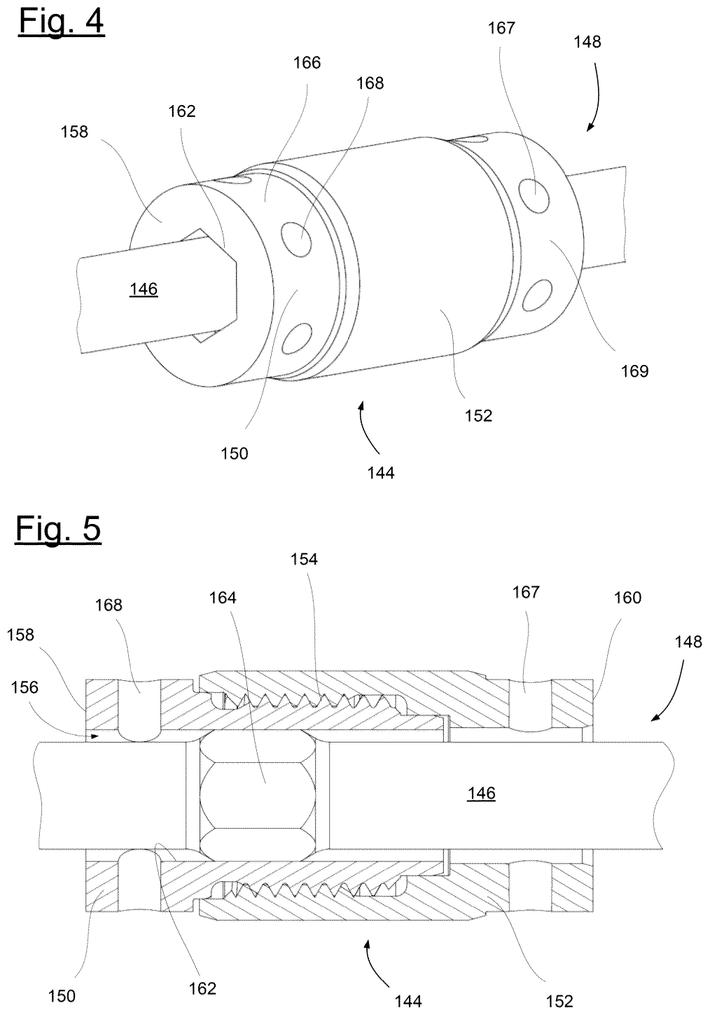

FIGS. 4 and 5 schematically show a bolt connection 148 with a pretensioning unit 144, wherein—for sake of clarity—the rotor blade segments 132, 134 have been omitted. The pretensioning unit 144 includes a first piece 150 and a second piece 152. Both pieces 150, 152 are sleeve-like and engage each other by being at least partially inserted into each other. More precisely, the first piece 150 is moved partially into the second piece 152. Both pieces 150 and 152 are directly coupled via a thread 154. The pretensioning unit 144 includes a through-hole 156. Via the thread 154, the first piece 150 and second piece 152 can be moved relative to each other along the corresponding bolt 146 by screwing.

With such pretensioning unit 144, the respective bolt 146 can be preloaded by pushing the first and second piece 150, 152 apart from each other against the respective connections ends 136, 138 of the rotor blade 110. Typically, before preloading (lengthening) the bolt 146, the bolt 146 is initially screwed into the connection ends 136, 138, such that the pretensioning unit 144 is in direct contact with the connections ends 136, 138. In other words, a first end 158 (part of the first piece 150) and an opposing second end 160 (part of the second piece 152) of the pretensioning unit 144 contacts the first or second connection end 136, 138 respectively.

As can be further seen from FIGS. 4 and 5, the first piece 150 is connected to the corresponding connecting bolt 146 in a form fit manner, such that a screwing force can be applied to the corresponding connecting bolt 146. In particular, the first piece 150 includes an inner hexagonal shaped section 162 engaging with a mating outer hexagonal shaped section 164 of the bolt 146. Thus, by rotation of the first piece 150, the bolt 146 is correspondingly rotated and can be screwed into the respective connection ends 136, 138 of the blade 110.

For actuating, that is, rotating, the first piece 150 includes a first tool engaging section 166 for a mounting tool or assembly tool. In the embodiment shown in FIGS. 4 and 5, the first tool engaging section 166 includes one or more boreholes 168, for example, mounting holes. Thus, mounting pins can be inserted into these boreholes 168 in order to rotate the first piece 150.

Afterwards, the bolt 146 is preloaded (lengthened) by screwing the first and second pieces 150, 152 apart from each other. The first piece 150 is hold in its position by a tool inserted into the borehole 168 in the first tool engaging section 166. The second piece 152 is screwed apart via another tool inserted in the borehole 167 in the second tool engaging section 169.

Further, it is noted that the outer contour of the pretensioning unit 144 is cylindrical, however other shapes are possible, as described in the following paragraph.

Alternatively, instead of boreholes 168, the first and second tool engaging sections 166, 169 can include a hexagonal shaped outer side for an assembly tool to engage with, as described above.

It is noted that instead of the first piece 150 the second piece 152 can be analogously configured to be rotated and to engage with the bolt 146 for screwing it.

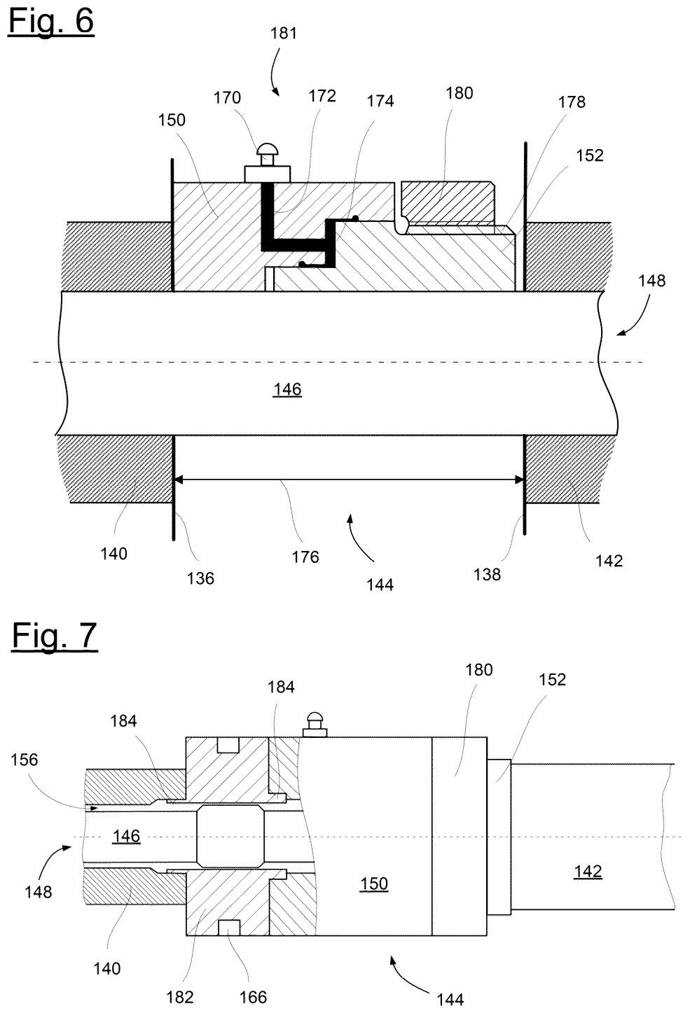

FIG. 6 schematically shows a pretensioning unit 144 according to another embodiment of the disclosure. In FIG. 6, again one bolt connection 148 between the first and second connection ends 136, 138 is shown, schematically indicated by bushings 140 and 142. Here, the pretensioning unit 144 is formed as a hydraulic nut unit.

Again, the pretensioning unit 144 includes a first piece 150 and a second piece 152. Both pieces 150, 152 are sleeve-like and engage each other by being at least partially inserted into each other, wherein the second piece 152 is at least partially slid into the first piece 150. Again, a through-hole 156 is formed. The first piece 150 includes a hydraulic port 170. Further, the first piece 150 includes a fluid channel 172, which fluidly connects the hydraulic port 170 with a hydraulic chamber 174. The hydraulic chamber 174 is formed by the first piece 150 and the second piece 152, wherein the chamber 174 is sealed, for example, by ring-like sealings like O-rings.

Via the hydraulic port 170, hydraulic pressure can be applied on the first and second piece 150, 152 in order to push the pieces apart from each other for preloading the bolt 146, similarly as described above. Again, a distance 176 between the connections ends 136, 138 is increased, for example, by up to 10 mm, preferably up to 7 mm, more preferably up to 5 mm, for example depending on an overall length of the respective bolt 146 and/or a diameter of the respective bolt 146. In order to lock the position of the first and second pieces 150, 152 after having them pushed apart, the second piece 152 has an outer thread 178, onto which a lock nut 180 is screwed. The lock nut 180 can be screwed against the first piece 150, that is, until it abuts against the first piece 150. Thus, an axial position of both pieces 150, 152 relative to each other along the bolt 146 (its longitudinal axis) can be secured. After locking, the hydraulic pressure can be released.

Although not shown in FIG. 6, similar to the embodiment according to FIGS. 4 and 5, the first or second piece 150, 152 can be configured to be rotated by an assembly tool and to engage with the bolt 146 for screwing it.

Further, optionally the hydraulic port 170 of each hydraulic nut unit 144 used for the bolt connections 148 is arranged at an outer side 181, the outer side 181 facing away from the longitudinal axis 120 in the mounted state of the segmented rotor blade 110. Thus, the hydraulic ports 170 are easily accessible for preloading the bolts 146.

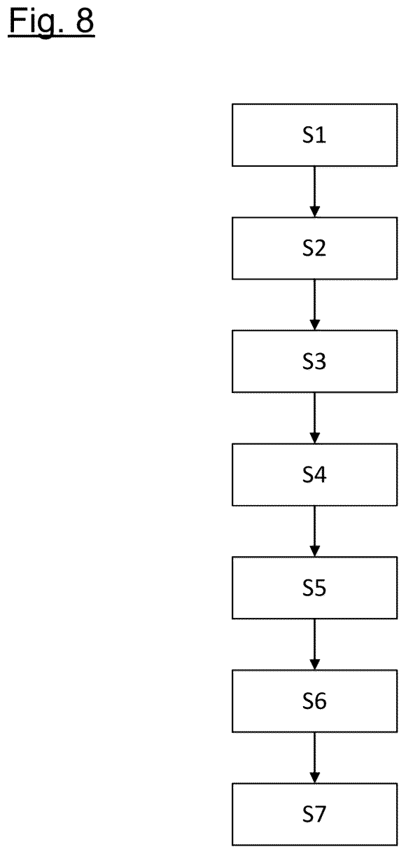

FIG. 7 schematically shows another embodiment of the disclosure. A pretensioning unit 144 is provided, which is indicated schematically and can be formed similar to the embodiments according to FIGS. 4 and 5 as well as 6. However, instead of the first or second piece 150, 152 being configured for screwing the bolt 146, an additional screwing piece 182 is provided, which is sleeve-like and mounted onto the bolt 146 between the pretension unit 144 and a respective connection end 136, 138 (or second bushing 130, 142). In the present case, the screwing piece 182 is located between the first piece 150 and the second connection end 138.

The screwing piece 182 is connected to the bolt 146 in a form fit manner, for example, by a hexagonal shaping. Further, the screwing piece 182 includes a tool engaging section 166 and can thus be actuated, that is, rotated. We refer to the above details which similarly apply.

Optionally, the screwing piece 182 includes centering means 184. The centering means 184 are provided on both ends facing a respective connection end 136, 138 and the pretensioning unit 144. Alternatively, the centering means are provided at one end only. The centering means 184 are ring-like protrusions which engage with the respective connection end 136, 138 and the pretensioning unit 144, that is, the first piece 150, in a form fit manner in order to center the pretensioning unit 144 with respect to the respective bolt 146.

FIG. 8 shows a flow chart for a method for connecting two segments 132, 134 of a rotor blade 110 with the help of pretensioning units 144 according to the embodiment of the disclosure of FIGS. 4 and 5 as described above.

In a first step S1, connection bolts 146 are partially screwed into the first connection end 136 of the first rotor blade segment 132, in particular into first bushings 140, in such a way that the connecting bolts 146 project from the first connection end 136.

In a further step S2, the sleeve-shaped pretensioning units 144 are provided.

In a further step S3, the pretensioning units 144 are mounted to the connecting bolts 146.

In a further step S4, the second connection end 138 of the second rotor blade segment 134 is brought close to the first connection end 136 of the first rotor blade segment 132.

In a further step S5, the connecting bolts 146 are partially screwed into the second connection end 138 of the second rotor blade segment 134, in particular into second bushings 142. The screwing of the bolts 146 can be done manually, by the screwing pieces 182 or by one of the first pieces 150 or second pieces 152 as described above. In this regard, the screwing pieces 182 or the first/second pieces 150 are coupled to the bolts 146 in a form fit manner as described above, in order to screw them into the first and/or second connections ends 136, 138.

In a further step S6, an axially directed force is provided between corresponding first and second pieces 150, 152 of each pretensioning unit 144. In this regard, the corresponding first and second pieces 150, 152 are screwed apart by the threaded connection 154.

In a further step S7, each corresponding first and second pieces 150, 152 of each pretensioning unit 144 are pushed apart from each other along the corresponding connecting bolts 146 against the respective connection ends 136, 138, such that the corresponding connecting bolts 146 are preloaded, as described above.

Instead of the pretensioning units 144 according to FIGS. 4 and 5, the method also is applicable to pretensioning units 144 according to the embodiments as described with regard to FIGS. 6 and 7 above. In case of using hydraulic nuts, one or more further steps are necessary, for example, lock nuts need to be screwed against the first pieces 150 as described above, in order to hold the first and second pieces 150, 152 in its axial positions relative to each other. According to an embodiment, a method for connecting two segments 132, 134 of a rotor blade 110 with the help of pretensioning units 144 includes the following steps (see also FIG. 8):

In a first step S1 (similar to above), connection bolts 146 are partially screwed into the first connection end 136 of the first rotor blade segment 132, in particular into first bushings 140, in such a way that the connecting bolts 146 project from the first connection end 136.

In a further step S2 (similar to above), the sleeve-shaped pretensioning units 144 are provided, wherein the pretensioning units 144 are hydraulic nuts as described above with respect to FIG. 7.

In a further step S3 (similar to above), the pretensioning units 144 are mounted to the connecting bolts 146.

In a further step S4 (similar to above), the second connection end 138 of the second rotor blade segment 134 is brought close to the first connection end 136 of the first rotor blade segment 132.

In a further step S5, the connecting bolts 146 are partially screwed into the second connection end 138 of the second rotor blade segment 134, in particular into second bushings 142. The screwing of the bolts 146 can be done manually, by the screwing pieces 182 or by one of the first pieces 150 or second pieces 152. In this regard, the screwing pieces 182 or the first/second pieces 150 are coupled to the bolts 146 in a form fit manner as described above, in order to screw them into the first and/or second connections ends 136, 138.

In a further step S6, each corresponding first and pieces 150, 152 are hydraulically pushed apart by the threaded connection 154. In this regard, the hydraulic port 172 of each pretensioning device 144 is connected to one or more hydraulic devices, which apply hydraulic pressure via the respective fluid channels 172 into the respective fluid chambers 174 to apply axial forces and push apart the first and second pieces 150, 152 along the corresponding connecting bolts 146 against the respective connection ends 136, 138, such that the corresponding connecting bolts 146 are preloaded, as described above.

In a further optional step S7, since each second piece 150 includes an external thread onto which a lock nut 180 is screwed, each lock nut 180 is screwed against each respective first piece 150, in order to hold each corresponding first and second pieces 150, 152 in position relative to each other.

In an optional further step (not shown in FIG. 8), the applied hydraulic pressure can be released after having locked the corresponding first and second pieces 150, 152 in its pushed apart positions.

It is understood that the foregoing description is that of the preferred embodiments of the invention and that various changes and modifications may be made thereto without departing from the spirit and scope of the invention as defined in the appended claims.

### REFERENCE SIGNS

100 wind turbine
102 tower
104 foundation
106 nacelle
108 rotor
110 rotor blade
112 rotor hub
114 rotor blade root area
116 transition area
118 profile area
120 longitudinal extension direction
122 pressure side
124 suction side
126 rotor blade connection end
128 flange connection
130 division area
132 first rotor blade segment
134 second rotor blade segment
136 first connection end
138 second connection end
140 first bushing
142 second bushing
144 pretensioning unit
146 connection bolt
148 bolt connection
150 first piece
152 second piece
154 thread
156 through-hole
158 first end
160 second end
162 inner hexagonal shaped section
164 outer hexagonal shaped section
166 first tool engaging section
167 borehole
168 borehole
169 second tool engaging section
170 hydraulic port
172 fluid channel
174 fluid chamber
176 distance
178 outer thread
180 lock nut
181 outer side
182 screwing piece
184 centering means
S1 to S7 step

1-16. (canceled)

17. A wind turbine rotor blade comprising:
a plurality of connecting assemblies and each of said connecting assemblies including:
first and second rotor blade segments having respective connection ends;
a connecting bolt threadably engaging into said first and second connection ends;
a sleeve-shaped pretensioning unit arranged between said first and second rotor blade segments and being mounted on said connecting bolt;
said pretensioning unit including first and second pieces mutually engaged in a form fit manner;
said first and second pieces being movable relative to each other along said connecting bolt by applying a force in an axial direction; and,
said first and second pieces being configured to be axially moved apart from each other along said connecting bolt against said respective connection ends so as to cause said connecting bolt to be preloaded.

18. The wind turbine rotor blade of claim 17, wherein said first piece and said second piece of said pretensioning unit are coupled to each other via a thread, and wherein said first and second piece are screwed apart from each other along said connecting bolt for preloading said connecting bolt.

19. The wind turbine rotor blade of claim 18, wherein said first piece or said second piece is connected to said connecting bolt in a form fit manner so as to permit a screwing force to be applied to said connecting bolt.

20. The wind turbine rotor blade of claim 18, wherein a screwing piece is located between said pretensioning unit and one of said rotor blade segments, said screwing piece being connected to said connecting bolt in a form fit manner so as to permit a screwing force to be applied to said connecting bolt.

21. The wind turbine rotor blade of claim 17, wherein said pretensioning unit is formed as a hydraulic nut unit.

22. The wind turbine rotor blade of claim 21, wherein said second piece has an external thread onto which a lock nut is screwed; said first piece and said second piece of said pretensioning unit are pushed apart from each other; and, wherein said lock nut is screwed against said first piece to hold said first piece and second piece in position relative to each other.

23. The wind turbine rotor blade of claim 21, wherein said first piece and said second piece of said pretensioning unit form a hydraulic chamber fluidly connected to a hydraulic port of said first piece to apply hydraulic pressure on said first piece and said second piece to push said first piece and said second piece apart from each other.

24. The wind turbine rotor blade of claim 21, wherein one of said first and second pieces is connected to said connecting bolt in a form fit manner so as to permit a screwing force to be applied to said connecting bolt.

25. The wind turbine rotor blade of claim 21, wherein a screwing piece is located between said pretensioning unit and one of the rotor blade segments; and, said screwing piece is connected to said connecting bolt in a form fit manner so as to permit a screwing force to be applied to said connecting bolt.

26. The wind turbine rotor blade of claim 21, wherein said wind turbine rotor blade defines a longitudinal axis and said hydraulic nut unit has a plurality of hydraulic nut ports; and, each of said hydraulic nut ports of said hydraulic nut units is arranged at an outer side with respect to said longitudinal axis of said wind turbine rotor blade.

27. The wind turbine rotor blade of claim 17, wherein said first or second piece of said pretensioning unit has a tool engaging section for an assembly tool.

28. The wind turbine rotor blade of claim 27, wherein said tool engaging section includes a hexagonal shaped outer side or one or more boreholes for inserting mounting pins or mounting bolts.

29. The wind turbine rotor of claim 17, wherein at least one of said first and second piece of said pretensioning unit or said screwing piece includes one or more centering devices for centering at least one of said first and second pieces along said connecting bolt with respect to the other connecting piece and/or the adjacent connection end.

30. A method of joining two rotor blade segments of a wind turbine rotor blade, the rotor blade segments having respective connection ends, the wind turbine rotor blade including a plurality of connecting assemblies and each of said connecting assemblies including: a connecting bolt threadably engaging into said first and second connection ends; a sleeve-shaped pretensioning unit arranged between said first and second rotor blade segments and being mounted on said connecting bolt; said pretensioning unit including first and second pieces mutually engaged in a form fit manner; said first and second pieces being movable relative to each other along said connecting bolt by applying a force in an axial direction; and, said first and second pieces being configured to be axially moved apart from each other along said connecting bolt against said respective connection ends so as to cause said connecting bolt to be preloaded, the method comprising the steps:
partially screwing the connecting bolts into the first connection end of the first rotor blade segment in such a way that the connecting bolts project from the first connection end;
mounting sleeve-shaped pretensioning units to the connecting bolts to be arranged between the rotor blade segments, wherein each pretensioning unit includes a first piece and a second piece, wherein the first piece and the second piece can be moved relative to each other along the corresponding connecting bolt, and wherein the first piece and the second piece engage each other in a form fit manner;
bringing the second connection end of the second rotor blade segment close to the first connection end of the first rotor blade segment;
partially screwing the connecting bolts into the second connection end;
providing an axially directed force between the first pieces and second pieces of each pretensioning unit;
axially pushing the first pieces and the second pieces of each pretensioning unit apart from each other along the corresponding connecting bolts against the respective connection ends, such that the corresponding connecting bolts are preloaded.

31. The method of claim 30, wherein the first piece and the second piece of each pretensioning unit are coupled to each other via a thread, and wherein, in the step of axially pushing, the first piece and the second piece of each pretensioning unit are screwed apart from each other for preloading the corresponding bolt.

32. The method of claim 30, wherein each pretensioning unit is formed as a hydraulic nut unit, and wherein, in the step of axially pushing, the first piece and the second piece of each pretensioning unit are hydraulically pushed apart from each other for preloading the corresponding bolt.

33. The method of claim 32, wherein each second piece comprises an external thread onto which a lock nut is screwed, and wherein the first piece and second piece of each pretensioning unit are pressed apart from each other, wherein the lock nut is screwed against the first piece, in order to hold the first piece and second piece in position relative to each other.
